(19) United States
(12) Patent Application Publication
(10) Pub. No.: US 2026/0140011 A1
(43) Pub. Date: May 21, 2026

(54) APPARATUS FOR USE IN THE INSPECTION OF AN OPHTHALMIC LENS, AND METHOD FOR HANDLING AN OPHTHALMIC LENS IN LENS INSPECTION

(71) Applicant: Alcon Inc., Fribourg (CH)

(72) Inventors: Felix Brinckmann, Roßdorf (DE); Marcus Heift, Großostheim (DE); Daniel Kessler, Linsengericht (DE)

(21) Appl. No.: 19/366,993

(22) Filed: Oct. 23, 2025

Related U.S. Application Data
(60) Provisional application No. 63/711,264, filed on Oct. 24, 2024.

(51) Int. Cl. G01M 11/02

(52) U.S. Cl. CPC G01M 11/0214

(57) ABSTRACT

An apparatus for use in the inspection of an ophthalmic lens comprises:

a cubic transparent inspection cuvette, the cuvette comprising walls defining a cubic cuvette interior space and a rectangular cuvette top opening;

a filling a placement funnel comprising a funnel top opening and a rectangular funnel bottom opening, and further comprising a seal;

a cuvette holder; and

a funnel holder.

Cuvette holder may hold cuvette at a cuvette filling and placement orientation,

Funnel holder may hold funnel at a funnel filling and placement orientation at which a funnel outlet axis coincides with longitudinal axis of cuvette interior space.

Cuvette holder and funnel holder are movable relative to each other to a filling and placement connection position, in which a liquid-tight connection between funnel bottom opening and cuvette top opening is formed by means of the seal.

### FIELD OF THE INVENTION

The present invention generally relates to the field of ophthalmic lens inspection. More particularly, the invention deals with an apparatus for use in the inspection of an ophthalmic lens, and with a method for handling an ophthalmic lens.

### BACKGROUND

In the manufacture of ophthalmic lenses, in particular contact lenses such as soft contact lenses, all lenses manufactured are inspected as to whether they are compliant with the strict quality criteria before they are released for distribution to customers. The lenses are typically inspected in inspection cuvettes immersed in an inspection liquid (e.g. water). For example, inspection cuvettes such as those shown in WO 2003/061855 may be used in lens manufacture, as the cuvettes shown there allow for a convenient and robust automated handling and inspection of the lenses.

Once a lens has successfully passed inspection, it is transferred to a primary packaging shell which is then filled with a storage solution (e.g. saline). A predetermined number of such primary packaging shells (e.g. three or five or any other number) arranged adjacent to one another may be sealed by a common foil strip to form a (blister) strip of primary packages each containing a single lens immersed in the storage solution.

A statistical process control (SPC) is performed to make sure the manufacturing process is working well and the lenses that have successfully passed the inspection in the manufacturing line indeed fulfil the strict quality criteria. The SPC comprises the drawing of individual sample strips of primary packages from the manufacturing line at certain times, and the lenses contained in the primary packages of these strips are then inspected once again to make sure they comply with the strict quality criteria. To do this, the individual primary packaging shells of the strip must be opened (the foil must be peeled off), and the lenses contained in the primary packaging shells need to be inspected again. This inspection performed in the SPC is performed, for example, in inspection cuvettes having a cubic shape (the volume of liquid contained in such cubic inspection cuvettes is much smaller, compared to the inspection cuvettes of the automated inspection directly in the production line). Such cubic inspection cuvettes are made of a transparent material and comprise a front wall, a rear wall (parallel to the front wall), two sidewalls (parallel to each other and perpendicular to the front wall and rear wall), a bottom wall and cuvette top opening through which the inspection liquid and the lens to be inspected may be inserted in (and later removed from) a cubic cuvette interior space defined by the walls of the inspection cuvette.

The cubic cuvette interior space has a predetermined length, a predetermined width and a predetermined depth. The predetermined length is typically selected such that the lens to be inserted is fully inserted into the cuvette interior space, and may be a multiple of the diameter of the lens (e.g. two times the lens diameter or more). The predetermined width is larger than the diameter of the lens so that the lens can be conveniently inserted in the cuvette interior space through the top opening of the cuvette. The predetermined depth is selected such that it is deeper than the sagittal height of the lens, but typically no deeper than the diameter of the lens, so that the lens may not inadvertently get turned upside down after it is inserted in the cuvette interior space (immersed in the liquid contained therein).

Insertion of the lens in such cuvettes is a cumbersome task and is presently performed manually by an operator who needs to take great care to avoid the occurrence of bubbles adhering to the lens, as in such instance the result of the inspection may not be used since bubbles adhering to the lens lead to false inspection results. In addition, in some instances the results of the inspection need to be verified which is also a cumbersome task as the lens must be manually taken out of the cuvette by the operator. And even though these problems are described in connection with the SPC here, the same problems may occur in case cubic inspection cuvettes as described above are used in the manufacture of lenses (i.e. inspection directly in the production line).

It is therefore an object of the present invention to overcome the afore-mentioned disadvantages and to suggest an apparatus and method that greatly simplifies the handling of the lenses when using cubic inspection cuvettes.

### SUMMARY OF THE INVENTION

In accordance with the invention, an apparatus for use in the inspection of an ophthalmic lens, in particular a contact lens such as a soft contact lens, is suggested, as it is specified by the features of the independent claim directed to the apparatus. Advantageous aspects of the apparatus are the subject of the dependent apparatus claims.

In particular, the apparatus according to the invention comprises:

an inspection cuvette made of a transparent material and having a cubic shape, the inspection cuvette comprising a front wall, a rear wall, two sidewalls, a bottom wall and a rectangular cuvette top opening, wherein the front wall, the rear wall, the two sidewalls and the bottom wall together define a cuvette interior space that is cubic and has a predetermined length, a predetermined width and a predetermined depth, and further define the rectangular cuvette top opening;

a filling and placement funnel comprising a funnel top opening and a funnel bottom opening, and further comprising a seal arranged at the funnel bottom opening and surrounding the funnel bottom opening, wherein the funnel bottom opening is rectangular and has a size that is equal to or smaller than the size of the rectangular cuvette top opening;

a cuvette holder for holding the inspection cuvette; and

a funnel holder for holding the filling and placement funnel.

The cuvette holder is configured to hold the inspection cuvette at a cuvette filling and placement orientation, at which a longitudinal axis of the cuvette interior space that extends in the direction of the length of the cuvette interior space and that runs normal to and through the cuvette top opening includes an acute angle with a vertical, and at which the cuvette top opening is arranged to face generally upwardly.

The funnel holder is configured to hold the filling and placement funnel at a funnel filling and placement orientation at which a funnel outlet axis of the filling and placement funnel that runs normal to and through the funnel bottom opening is arranged coincident with the longitudinal axis of the cuvette interior space when the cuvette holder holds the inspection cuvette at the cuvette filling and placement orientation.

When the cuvette holder holds the inspection cuvette at the cuvette filling and placement orientation and the funnel holder holds the filling and placement funnel at the funnel filling and placement orientation, the inspection cuvette holder and the funnel holder are configured to be movable relative to each other to a filling and placement connection position, in which a liquid-tight connection between the funnel bottom opening of the filling and placement funnel and the cuvette top opening is formed by means of the seal surrounding the funnel bottom opening, and away from this filling and placement connection position to release the liquid-tight connection.

According to one aspect of the apparatus according to the invention, the acute angle included by the longitudinal axis of the cubic interior space and the vertical is in a range of 30° to 60°, and especially is about 45°.

According to a further aspect of the apparatus according to the invention, the apparatus further comprises a liquid supply tube having a liquid supply tube outlet that is positionable at or above the funnel top opening of the filling and placement funnel, for the supply of inspection liquid into the cuvette interior space through the funnel top opening, the funnel bottom opening and the cuvette top opening, and further into the filling and placement funnel, when the cuvette holder and the funnel holder are arranged in the filling and placement connection position.

According to another aspect of the apparatus according to the invention, the apparatus further comprises a suction supply tube arranged to be movable to an active position in which the suction supply tube extends through the funnel top opening, the funnel bottom opening and the cuvette top opening into the cuvette interior space when the cuvette holder and the funnel holder are arranged in the filling and placement connection position, and to an inactive position in which the suction supply tube is completely arranged outside the filling and placement funnel.

In accordance with still another aspect of the apparatus according to the invention, the apparatus further comprises a wiper arranged to be movable to a cleaning position in which the wiper contacts the end faces of the walls of the inspection cuvette that surround the cuvette top opening, i.e. the end faces of the front wall, the rear wall, and the two sidewalls, when the cuvette holder and the funnel holder are arranged away from the filling and placement connection position, and to a remote position in which the wiper is arranged remote from the cuvette top opening.

Yet in accordance with another aspect of the apparatus according to the invention, the apparatus further comprises a lens gripper arranged to be movable through the funnel top opening into the filling and placement funnel, for insertion of an ophthalmic lens in the filling and placement funnel.

In accordance with a further aspect of the apparatus according to the invention, the apparatus further comprises:

an emptying and removal funnel having a funnel top opening and a funnel bottom opening, a lid movably arranged between a closed position in which the lid closes the funnel top opening in a liquid-tight manner and an open position, and a seal arranged at the funnel bottom opening and surrounding the funnel bottom opening, wherein the funnel bottom opening is rectangular and has a size that is equal to or larger than the size of the rectangular cuvette top opening; and

a further funnel holder for holding the emptying and removal funnel.

The further funnel holder is configured to hold the emptying and removal funnel at a funnel start orientation at which a funnel outlet axis of the emptying and removal funnel that runs normal to and through the funnel bottom opening is arranged coincident with the longitudinal axis of the cubic cuvette interior space when the cuvette holder holds the inspection cuvette at the cuvette filling and placement orientation at which the longitudinal axis of the cuvette interior space includes the acute angle with the vertical, and at which the cuvette top opening is arranged to face generally upwardly.

When the cuvette holder holds the inspection cuvette at the cuvette filling and placement orientation and the further funnel holder holds the emptying and removal funnel at the funnel start orientation, the further funnel holder and the inspection cuvette holder are configured to be movable relative to each other to an emptying and removal connection position, in which a liquid-tight connection between the funnel bottom opening of the emptying and removal funnel and the cuvette top opening is formed by means of the seal surrounding the funnel bottom opening, and away from this removal and emptying connection position to release the liquid-tight connection.

According to another aspect of the apparatus according to the invention, the apparatus further comprises a further liquid supply tube having a liquid supply tube outlet positionable at or above the funnel top opening when the further funnel holder and the cuvette holder are arranged in the emptying and removal connection position and hold the emptying and removal funnel at the funnel start orientation and the inspection cuvette at the cuvette filling and placement orientation, for filling the emptying and removal funnel with an inspection liquid.

According to still another aspect of the apparatus according to the invention, the apparatus further comprises a rotatable support on which the cuvette holder and the further funnel holder are arranged. The rotatable support is configured to rotate the cuvette holder and the further funnel holder arranged thereon in the emptying and removal connection position by a predetermined rotational angle to an emptying and removal orientation in which the longitudinal axis of the cuvette interior space is arranged to include an obtuse angle with the vertical, and in which the cuvette top opening is arranged to face generally downwardly.

According to yet another aspect of the apparatus according to the invention, the emptying and removal funnel has an interior space comprising a portion that is arranged at a level above the cuvette top opening when the rotatable support is arranged at the emptying and removal orientation.

Also in accordance with the invention, a method for handling an ophthalmic lens in lens inspection is suggested, as it is specified by the features of the independent claim directed to the method. Advantageous aspects of the method are the subject of the dependent method claims.

In particular, the method for handling an ophthalmic lens in lens inspection according to the invention comprises:

providing an apparatus according to the invention as described above;

moving the cuvette holder holding the inspection cuvette at the cuvette filling and placement orientation and the funnel holder holding the filling and placement funnel at the funnel filling and placement orientation relative to each other to the filling and placement connection position to form the liquid-tight connection between the funnel bottom opening of the filling and placement funnel and the cuvette top opening;

filling an inspection liquid through the funnel top opening, the funnel bottom opening and the cuvette top opening into the inspection cuvette until the cuvette interior space is completely filled with inspection liquid, and then continuing to fill inspection liquid through the funnel top opening into the filling and placement funnel up to a predetermined level;

placing an ophthalmic lens to be inspected in the inspection liquid in the filling and placement funnel through the funnel top opening, and allowing the ophthalmic lens placed in the inspection liquid to settle down and move through the funnel bottom opening and the cuvette top opening into the inspection liquid contained in the cubic interior space of the cubic inspection cuvette;

completely removing the inspection liquid from the filling and placement funnel while keeping the inspection cuvette filled with inspection liquid and retaining the ophthalmic lens immersed in the inspection liquid contained in the inspection cuvette; and

moving the cuvette holder holding the inspection cuvette with the inspection liquid and the ophthalmic lens immersed therein and the filling and placement funnel away from the filling and placement position.

According to one aspect of the method according to the invention, the method further comprises the step of

removing inspection liquid, if any, from the end faces of the front wall, the rear wall, and the two sidewalls surrounding the cuvette top opening of the inspection cuvette, when the cuvette holder and the funnel holder are arranged away from the filling and placement connection position.

According to another aspect of the method according to the invention, the method further comprises the steps of

providing the further funnel holder holding the emptying and removal funnel at the funnel start orientation, with the lid in the open position;

providing the cuvette holder holding the inspection cuvette with the inspection liquid and the ophthalmic lens contained therein at the filling and placement orientation;

moving the cuvette holder and the further funnel holder relative to each other to the emptying and removal position in which a liquid-tight connection between the funnel bottom opening of the emptying and removal funnel and the cuvette top opening is formed;

filling the emptying and removal funnel with inspection liquid through the funnel top opening up to a predetermined level;

closing the lid of the emptying and removal funnel;

rotating the rotational support on which the cuvette holder and the further funnel holder are arranged in the emptying and removal position to the emptying and removal orientation, thus allowing the ophthalmic lens to slide out of the inspection cuvette into the emptying and removal funnel; and

moving the lid of the emptying and removal funnel to the open position, thus removing the ophthalmic lens and the inspection liquid from the emptying and removal funnel and the inspection cuvette.

According to still another aspect of the method according to the invention, the method further comprises the steps of:

after removal of the ophthalmic lens and the inspection liquid from the emptying and removal funnel and the inspection cuvette, rotating the rotational support from the emptying and removal orientation back to the funnel start orientation, and

moving the further funnel holder and the cuvette holder away from the emptying and removal position to release the liquid-tight connection between the funnel bottom opening of the emptying and removal funnel and the cuvette top opening.

Optionally, the method may further comprise the step of

removing inspection liquid, if any, from the end faces of the front wall, the rear wall, and the two sidewalls surrounding the cuvette top opening of the inspection cuvette, when the cuvette holder and the further funnel holder are arranged away from the filling and placement connection position.

The apparatus and method according to the invention offer a number of advantages. First of all, the process steps can be automated either completely or nearly completely. This is possible even though insertion of the lens into the cubic interior space of the cubic inspection cuvette is a delicate task. To achieve this, first of all the cubic inspection cuvette is arranged on the cuvette holder which is configured to hold the inspection cuvette in the cuvette filling and placement orientation, in which the longitudinal axis of the cubic cuvette interior space is arranged to include an acute angle with the vertical. Preferred acute angles are within a range of 30° to 60°, and in particular the acute angle may be 45°. In this filling and placement orientation, the rectangular cuvette top opening faces generally upwardly. The term 'generally upwardly' means that the cuvette top opening faces in a direction between the horizontal direction and the vertical upward direction. Accordingly, in the cuvette filling and placement orientation it is possible to fill the cuvette interior space of the inspection cuvette with inspection liquid (e.g. water or saline) through the cuvette top opening, and to subsequently insert and keep the ophthalmic lens immersed in the inspection liquid contained in the cuvette interior space. By contrast, in a cuvette emptying and removal orientation the longitudinal axis of the cuvette interior space includes an obtuse angle with the vertical and faces generally downwardly. Preferred obtuse angles are within a range of 120° to 150°, and in particular the obtuse angle may be 135°. The term 'generally downwardly' means that the cuvette top opening faces in a direction between the horizontal direction and the vertical downward direction. In the cuvette emptying and removal orientation, the inspection liquid contained in the cuvette interior space may be drained from the cuvette interior space through the cuvette top opening and the ophthalmic lens be removed from the cuvette interior space.

The filling and placement funnel is arranged on a funnel holder configured to hold the filling and placement funnel in a funnel filling and placement orientation, in which the funnel outlet axis that runs normal to the funnel outlet opening coincides with the longitudinal axis of the cuvette interior space arranged in the cuvette filling and placement orientation. The funnel outlet opening is rectangular (as is the cuvette top opening), and its size is equal to or smaller than the cuvette top opening. When the filling and placement funnel is held in the funnel filling and placement orientation and the inspection cuvette is held in the cuvette filling and placement orientation, the filling and placement funnel and the inspection cuvette are moved towards one another by moving the cuvette holder and the funnel holder to a filling and placement connection position in which the seal surrounding the funnel bottom opening of the filling and placement funnel abuts against the cuvette top opening. While generally either the funnel holder may be moved towards the cuvette holder which may be arranged stationary, or the cuvette holder may be moved towards the funnel holder which may be arranged stationary, or both the funnel holder as well as the cuvette holder may be movable, in one embodiment the funnel holder is arranged stationary and the cuvette holder is movable. In the filling and placement connection position, a liquid-tight connection is formed between the funnel outlet opening and the cuvette top opening. In this filling and placement connection position, the cuvette interior space may be filled with inspection liquid through the funnel top opening, the funnel bottom opening and the cuvette top opening.

Inspection liquid may be supplied through the funnel top opening. One possible way to do this is using a liquid supply tube, and positioning the outlet end of the liquid supply tube at or above the funnel top opening. Due to the liquid-tight connection between the funnel bottom opening and the cuvette top opening (by means of the seal) the inspection liquid flows out of the outlet end of the liquid supply tube through the funnel top opening, through the interior space of the filling and placement funnel, and through the funnel bottom opening and the cuvette top opening into the cuvette interior space until the cuvette interior space is completely filled with liquid. Continuing to supply inspection liquid leads to the filling and placement funnel getting filled with inspection liquid up to a predetermined level (which may, for example, be a level close to the funnel top opening, so that at least 70%-80% of the volume of the funnel interior space is filled with inspection liquid. Thereafter, the ophthalmic lens is inserted through the funnel top opening into the inspection liquid in the funnel interior space of the filling and placement funnel. While lens insertion into the liquid in the funnel interior space can be performed in a number of different ways, a preferred way is to use a lens gripper. Lens grippers are well-known in the art. They transport an ophthalmic lens adhered to the distal end surface of the gripper head to any desired destination location (e.g. through the application of vacuum through the gripper shaft and through openings in the gripper head in order to make the lens adhere to the distal end surface of the gripper head). Once the destination location is reached, application of vacuum is terminated and, if desired, overpressure may be applied through the gripper shaft and through the openings in the gripper head to release the ophthalmic lens from the distal end surface of the gripper head. In accordance with the instant invention, the ophthalmic lens is inserted in the inspection liquid contained in the interior space of the filling and placement funnel, allowing the lens to settle down (due to gravity) in the inspection liquid in the interior space of the filling and placement funnel. The filling and placement funnel may include an inclined surface that runs parallel to the funnel outlet axis, so that the ophthalmic lens, upon settling down and reaching this inclined surface, tilts and slides along this inclined surface of the filling and placement funnel towards and through the funnel bottom opening, and further downwards through the cuvette top opening into the cuvette interior space which is also filled with inspection liquid. The ophthalmic lens does not get stuck at the funnel bottom opening, but rather smoothly slides into the cuvette interior space. This is possible since the shape of the funnel bottom opening is rectangular (as is the shape of the cuvette top opening) and since the size of the funnel bottom opening is equal to or smaller than the size of the cuvette top opening, so that the walls of the inspection cuvette about the rectangular cuvette top opening may not form any steps or abutment surfaces (edges or surfaces which may prevent the ophthalmic lens from smoothly sliding into the cuvette interior space. The length, width and depth of the interior space of the inspection cuvette are chosen such that the lens is fully accommodated within the cuvette interior space immersed in the inspection liquid contained therein, and at the same time the lens may not inadvertently get turned upside down. Thus, insertion of the ophthalmic lens can be performed in an easy and reliable manner and fully automated,

Once insertion of the ophthalmic lens in the cuvette interior space is completed in the manner described above, in order to be able to further handle the inspection cuvette in lens inspection the liquid contained in the filling and placement funnel must be removed from the interior space of the filling and placement funnel before moving the filling and placement funnel and the inspection cuvette away from the filling and placement connection position (in which the liquid-tight connection is formed). Otherwise, the liquid contained in the interior space of the filling and placement funnel may get spilled and may even wet the outer walls of the inspection cuvette which is unwanted. This liquid removal may be performed, for example, with the aid of a suction supply tube. The suction supply tube may be movable to an active position in which the suction supply tube extends through the funnel top opening of the filling and placement funnel, the funnel bottom opening and the cuvette top opening into the cuvette interior space when the cuvette holder and the funnel holder are still arranged in the filling and placement connection position (liquid-tight connection). The active position of the open end of the suction supply tube in the cuvette interior space may be chosen to be arranged close to the cuvette top opening, so that at least 70-80% of the volume of the cuvette interior space remains filled with inspection liquid (with the lens fully immersed therein) after liquid removal. Once removal of the inspection liquid from the filling and placement funnel is completed, the suction supply tube may be moved to an inactive position in which the suction supply tube is completely arranged outside the filling and placement funnel.

To prevent any droplets of the inspection liquid from adhering to the end faces of the walls of the inspection cuvette surrounding the rectangular cuvette top opening, the apparatus may further comprise a wiper. The wiper is movable and may be moved to a cleaning position in which the wiper contacts the end faces of the walls of the inspection cuvette surrounding the cuvette top opening (i.e. the end faces of the front wall, the rear wall, and the two sidewalls). In the active position, the wiper removes any inspection liquid (if present) from the end faces of the walls of the inspection cuvette surrounding the cuvette top opening, e.g. through application of suction, with the aid of capillary forces, or by any other suitable means. Thereafter, the wipe is moved back to the remote position.

The inspection cuvette is now ready for further handling in lens inspection, with the ophthalmic lens contained in the cuvette interior space and immersed in the inspection liquid, so that the ophthalmic lens can be inspected in the inspection cuvette in a known manner (not part of this invention).

Once lens inspection is completed, it may be necessary to remove the ophthalmic lens from the inspection cuvette again without damaging the ophthalmic lens, for example to double-check/verify any measurement results obtained in lens inspection. This is done in a somewhat similar manner as lens insertion, however, with the aid of an emptying and removal funnel which is arranged on a further funnel holder. This emptying and removal funnel, like the filling and placement funnel, has a funnel top opening and a funnel bottom opening. In addition, the emptying and removal funnel further comprises a movably arranged lid for opening (open position) and closing (closed position) the funnel top opening. Like the filling and placement funnel, the emptying and removal funnel comprises a seal arranged at the funnel bottom opening and surrounding the funnel bottom opening. The funnel bottom opening of the emptying and removal funnel is rectangular.

The further funnel holder (on which the emptying and removal funnel is arranged) is configured to hold the emptying and removal funnel at a funnel start orientation at which the funnel outlet axis that runs normal to and through the funnel bottom opening is arranged coincident with the longitudinal axis of the cubic cuvette interior space when the cuvette holder holds the inspection cuvette at the cuvette filling and placement orientation, at which the cuvette top opening is arranged to face generally upwardly (see above). The inspection liquid and the lens are still contained in the cuvette interior space. The further funnel holder and the cuvette holder are then moved towards each other. Again, while one of the further funnel holder and the cuvette holder may be movable while the other one may be arranged stationary, both the further funnel holder as well as the cuvette holder may be movable. By way of example, and similar to what has been described above for the filling and placement funnel, in one embodiment the cuvette holder is movable while the further funnel holder is arranged stationary. The further funnel holder and the cuvette holder are moved towards each other (in the embodiment only the cuvette holder is moved) to an emptying and removal connection position, in which a liquid-tight connection between the funnel bottom opening of the emptying and removal funnel and the cuvette top opening is formed by means of the seal surrounding the funnel bottom opening. This emptying and removal connection position is similar to the filling and placement connection position.

Inspection liquid may then be filled into the interior space of the emptying and removal funnel through the funnel top opening up to a predetermined level into the interior space of the emptying and removal funnel so that first the interior space of the inspection cuvette is completely filled with inspection liquid again, and then the interior space of the emptying and removal funnel is filled up to a level at which at least 70%-80% of the volume of the funnel interior space is filled with inspection liquid. Similar to filling the interior space of the filling and placement funnel, filling the interior space of the emptying and removal funnel may be performed with the aid of a further liquid supply tube (which may be the same liquid supply tube as that used to fill the inspection liquid into the filling and placement funnel, or which may be a different liquid supply tube). The further liquid supply tube may have a liquid supply tube outlet that is positionable at or above the funnel top opening of the emptying and removal funnel, and the interior space of the emptying and removal funnel may then be filled with inspection liquid through the funnel top opening. Once filling inspection liquid into the interior space of the emptying and removal funnel is completed, the lid of the emptying and removal funnel is closed (e.g. with the aid of an actuator), so that the funnel top opening of the emptying and removal funnel is sealed by the lid in a liquid-tight manner.

An embodiment of the apparatus according to the invention comprises a rotatable support on which both the cuvette holder and the further funnel holder are arranged and to which they may be mounted. This rotatable support is now rotated by a predetermined rotational angle (e.g. by 90°) to an emptying and removal orientation in which the longitudinal axis of the cuvette interior space is arranged to include the obtuse angle with the vertical. In this emptying and removal orientation, the cuvette top opening is arranged to face generally downwardly. However, the emptying and removal funnel and the inspection cuvette are still arranged in the emptying and removal connection position with the liquid-tight connection, and the lid of the emptying and removal funnel is still closed. In this emptying and removal orientation, the ophthalmic lens immersed in the inspection liquid contained in the interior space of the inspection cuvette may slide down along an inner surface of the front wall or rear wall of the inspection cuvette, and further through the cuvette top opening (facing generally downwardly), the funnel bottom opening and into the interior space of the emptying and removal funnel, until it may finally abut against the lid.

To make sure the lens slides down and out of the inspection cuvette into the interior space of the emptying and removal funnel, the inspection cuvette should remain completely filled with inspection liquid at all times. This includes the time after rotation of the inspection cuvette and the emptying and removal funnel to the emptying and removal orientation (by means of the rotational support) is completed. For that reason, the interior space of the emptying and removal funnel comprises a portion that is arranged at a level above the cuvette top opening when the rotatable support has been rotated to the emptying and removal orientation (with the emptying and removal funnel and the inspection cuvette arranged thereon being also arranged at the emptying and removal orientation). The interior space of the emptying and removal funnel must therefore be filled to a predetermined level which is above the cuvette top opening after rotation. Any air entrapped between the upper surface of the inspection liquid and the lid after filling the interior space of the emptying and removal funnel and prior to rotation is displaced - during rotation - only into that portion of the emptying and removal funnel that is arranged above the cuvette top opening after rotation. Accordingly, no entrapped air may enter the cuvette interior space at any time, neither during rotation nor after completion of the rotation. Thus, the ophthalmic lens may slide out of the cuvette interior space of the inspection cuvette (due to gravity) and into the interior space of the emptying and removal funnel while always being fully immersed in the inspection liquid.

Finally, the lid is moved to the open position (e.g. with the aid of the said actuator) so that the inspection liquid contained in the interior space of the emptying and removal funnel and in the cuvette interior space of the inspection cuvette may flow out of the emptying and removal funnel through the top opening thereof, thus flushing the ophthalmic lens out. The ophthalmic lens may be retained by a mesh that is arranged in the flow of inspection liquid out of the emptying and removal funnel, and can be further used, for example, for verification of the measurement results obtained by the lens inspection

The rotatable support is then rotated back so that the emptying and removal funnel arranged on the further funnel holder is arranged at the funnel start orientation again and the inspection cuvette arranged on the cuvette holder is held at the filling and placement orientation again. At that time, the emptying and removal funnel and the inspection cuvette are still arranged at the emptying and removal position (liquid-tight connection), so that the cuvette holder then moves the inspection cuvette away from this emptying and removal position to spatially separate the inspection cuvette from the emptying and removal funnel.

Optionally, after the emptying and removal funnel and the inspection cuvette are moved away from the emptying and removal position (liquid-tight connection) it is possible to remove any inspection liquid from the end faces of the front wall, the rear wall, and the two sidewalls surrounding the cuvette top opening of the inspection cuvette to avoid that any liquid may wet the outer walls of the inspection cuvette, similar to how this is done after the filling and placement funnel and the inspection cuvette are moved away from the filling and placement position (liquid-tight connection), e.g. with the aid of the wiper.

### BRIEF DESCRIPTION OF THE DRAWINGS

Further advantageous aspects of the apparatus and method according to the invention become apparent from the description of embodiments of the invention with the aid of the drawings in which:

FIG. 1 shows components of an embodiment of the apparatus according to the invention, with the filling and placement funnel arranged at the funnel filling and placement orientation, and with the inspection cuvette arranged at the cuvette filling and placement orientation;

FIG. 2 shows the components of the embodiment of the apparatus of FIG. 1 together with a liquid supply tube, with the inspection cuvette and the filling and placement funnel arranged at the filling and placement connection position;

FIG. 3 shows the components of the embodiment of the apparatus arranged as in FIG. 2, after filling liquid from the liquid supply tube into the inspection cuvette and the filling and placement funnel;

FIG. 4 shows the components of the embodiment of the apparatus arranged as in FIG. 3, with a lens to be inserted in the filling and placement funnel adhered to a lens gripper arranged above the filling and placement funnel;

FIG. 5 shows the components of the embodiment of the apparatus arranged as in FIG. 4, with the lens placed in the filling and placement funnel;

FIG. 6 shows the components of the embodiment of the apparatus arranged as in FIG. 5, however, with the lens arranged in the inspection cuvette, and with the distal end of the suction supply tube arranged in the inspection cuvette close to the cuvette top opening;

FIG. 7 shows the components of the embodiment of the apparatus arranged as in FIG. 6, with the inspection liquid removed from the filling and placement funnel;

FIG. 8 shows the components of the embodiment of the apparatus with the filling and placement funnel and the inspection cuvette arranged away from the filling and placement connection position, and with the wiper arranged in the active position;

FIG. 9 shows the components of the embodiment of the apparatus arranged as in FIG. 1, with the wiper arranged in the remote position, and with the lens arranged in the inspection cuvette immersed in the inspection liquid;

FIG. 10 shows some further components of an embodiment of the apparatus according to the invention, with the emptying and removal funnel arranged at the funnel start orientation, and with the inspection cuvette still arranged at the cuvette filling and placement orientation;

FIG. 11 shows the component of the embodiment of the apparatus shown in FIG. 10, with the emptying and removal funnel and the inspection cuvette (containing the lens immersed in the inspection liquid) arranged at the emptying and removal connection position;

FIG. 12 shows the components of the embodiment of the apparatus arranged as shown in FIG. 11, together with a further liquid supply tube;

FIG. 13 shows the components of the embodiment of the apparatus arranged as shown in FIG. 11, with the lid of the emptying and removal funnel in the closed position;

FIG. 14 shows the components of the embodiment of the apparatus arranged as shown in FIG. 13, however, after rotation of the rotational support by a predetermined angle so that the inspection cuvette and the emptying removal funnel are arranged at the emptying and removal orientation;

FIG. 15 shows the components of the embodiment of the apparatus arranged as shown in FIG. 14, with the lens arranged in the interior space of the emptying and removal funnel and the lid of the emptying and removal funnel still in the closed position;

FIG. 16 shows the components of the embodiment of the apparatus as shown in FIG. 15, with the lid of the emptying and removal funnel in the open position, and with a mesh arranged beneath to retain the lens flushed out, and

FIG. 17 shows the components of the embodiment of the apparatus shown in FIG. 16, with the rotational support rotated back to the orientation shown in FIG. 13.

### DESCRIPTION OF EMBODIMENTS

In the following, embodiments of the apparatus and method according to the invention are described by way of example. For the sake of simplicity of the drawings, not each and every component is shown in each of the drawings.

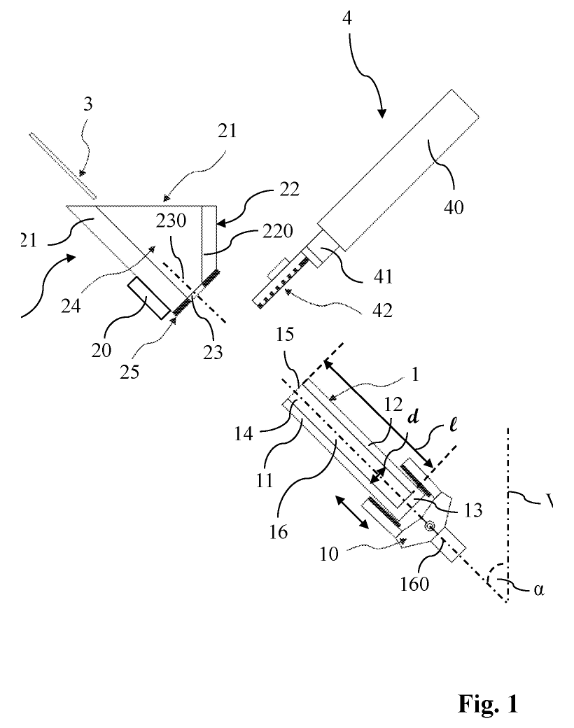

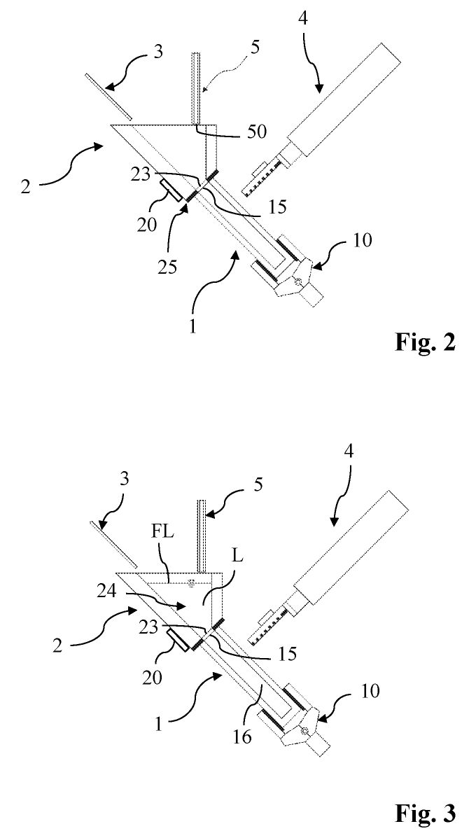

FIG. 1 shows some components of an embodiment of the apparatus according to the invention, with the components arranged in an initial position. The apparatus comprises an inspection cuvette 1 arranged on a cuvette holder 10 which is movable in the direction of the double-headed arrow. The apparatus further comprises a filling and placement funnel 2 arranged on a funnel holder 20. The apparatus further comprises a suction supply tube 3, a wiper 4, and a liquid supply tube 5 (see FIG. 2).

Inspection cuvette 1 has an outer cubic shape and is made of a transparent material, for example fused silica, and has a cubic shape, of which only the front wall 11, the rear wall 12, a bottom wall 13 and two sidewalls of which only one sidewall 14 is visible in FIG. 1. Inspection cuvette 1 further comprises a top opening 15. The afore-mentioned walls of the inspection cuvette 1 define a cuvette interior space 16 which is also cubic and has a predetermined length l, a predetermined width w (not visible) and a predetermined depth d, so that the cuvette top opening 15 is rectangular. The length l is substantially larger than the diameter of the lens to be inspected. Typically, the lens diameter may range up to 14 mm - 17 mm for soft contact lenses. By way of example, the length l of the interior space may be 40 mm. The width w is also larger than the diameter of the lens to be inspected, but not substantially larger. For example, the width may be 20 mm. The depth d is also larger than the maximum sagittal height of the lens, but not very substantially larger. Typically, the maximum sagittal height of the lens is up to 4 mm, and the depth d of inspection cuvette may be 5 mm, for example.

The reason for choosing the dimensions of the interior space 16 of the inspection cuvette 1 is, that the length l should be dimensioned to allow the lens to sufficiently move down in the inspection liquid contained in the interior space 16 of the inspection cuvette 1 until it reaches the bottom wall 13 so that the lens may not inadvertently get lost from the inspection cuvette 1 through the cuvette top opening 15. The width w and the depth d are not substantially larger than the corresponding dimension (lens diameter, sagittal height) of the lens. As regards the width w, the reason for this is that the lens should not be allowed to (laterally) move to a large extent in the cuvette interior space, so that the lens should be at the desired position during its inspection in the cuvette. As regards the depth d, the reason for this is that once the lens is inserted in the interior space 16 of inspection cuvette 1, the lens should not be able to change its orientation in the cuvette interior space anymore (i.e. the lens should not be able to get turned upside down in the interior space 16 of inspection cuvette 1 during handling of the inspection cuvette 1). Thus, once properly inserted into the interior space 16 of the inspection cuvette 1 the lens has the desired orientation (right side up) during inspection.

Filling and placement funnel 2 comprises a funnel top opening 21, a funnel wall 22, and a funnel bottom opening 23, together defining an interior space 24 of filling and placement funnel 2. A seal 25 is arranged at the funnel bottom opening 23, and surrounds the funnel bottom opening 23. Funnel bottom opening 23 is rectangular and has a size that is equal to or a little smaller than the size of rectangular cuvette top opening 15. Funnel wall 22 comprises a vertically extending funnel wall portion 220 and an inclined funnel wall portion 221, the purpose of which will be explained further below.

Suction supply tube 3 is a tube that has a small inner diameter (e.g. a few millimeters) through which vacuum may be supplied. Suction supply tube 3 may be made of a rigid and non-corrosive material, for example plastics or stainless steel.

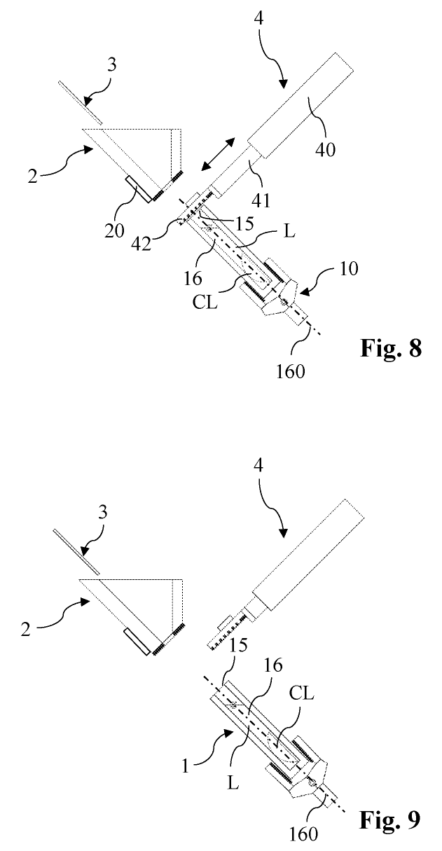

Wiper 4 comprises a stator 40 and a slider 41 to the distal end of which a liquid removal head 42 is attached. Wiper 4 is shown in FIG. 1 in the remote position (inactive) in which the slider 41 is retracted. When the wiper 4 is in the active position, the slider 41 is extended and the contact surface of liquid removal head 42 contacts the end faces of the walls of the inspection cuvette 1 surrounding the cuvette top opening 15 (see FIG. 8).

In FIG. 1, cuvette holder 10 holds inspection cuvette 1 at a cuvette filling and placement orientation, at which a longitudinal axis 160 of cuvette interior space 16 that extends in the direction of the length l of cuvette interior space 16 and that runs normal to and through the cuvette top opening 15 includes an acute angle α with a vertical V. The cuvette top opening is arranged to face generally upwardly (i.e. in any event upwardly relative to a horizontal). The acute angle α included by the longitudinal axis 160 of the cubic interior space 16 and the vertical is in a range of 30° to 60°, and in the embodiment shown it is 45°.

Funnel holder 20 holds filling and placement funnel 2 at a funnel filling and placement orientation at which a funnel outlet axis 230 that runs normal to and through funnel bottom opening 23 is arranged coincident with the longitudinal axis 160 of cuvette interior space 16.

In the following, with the aid of an embodiment of the apparatus an embodiment of the method according to the invention will be explained step by step.

As can be seen in FIG. 2, cuvette holder 10 still holds inspection cuvette 1 at the cuvette filling and placement orientation and funnel holder 20 still holds filling and placement funnel 2 at the funnel filling and placement orientation. When compared to FIG. 1, however, inspection cuvette holder 10 and funnel holder 20 have been moved relative to each other to a filling and placement connection position shown in FIG. 2. In the embodiment shown, cuvette holder 10 has moved inspection cuvette 1 towards filling and placement funnel 2 until the filling and placement connection position has been reached, while filling and placement funnel 2 has been held stationary by funnel holder 20. In the filling and placement connection position, a liquid-tight connection is formed between funnel bottom opening 23 of filling and placement funnel 2 and cuvette top opening 15 of inspection cuvette 1. This liquid-tight connection is formed by means of the seal 25 surrounding the funnel bottom opening 23. As can be seen, the apparatus further comprises a liquid supply tube 5 having a liquid supply tube outlet 50 which is positioned at or above the funnel top opening 21 of filling and placement funnel 2.

The next step, as shown in FIG. 3, is filling both the inspection cuvette 1 and the filling and placement funnel 2 with inspection liquid, e.g. water (or saline). For that purpose, inspection liquid L is supplied through liquid supply tube 5 into cuvette interior space 16 through funnel top opening 21, funnel bottom opening 23 and cuvette top opening 15 until cuvette interior space 16 is completely filled with inspection liquid L. Supply of inspection liquid L is continued until interior space 24 of filling and placement funnel 2 is filled to a predetermined (filling) level FL which is close to the funnel top opening 21. This predetermined level FL is such that at least 70%-80% of the volume of interior space 24 of filling and placement funnel 2 is filled with inspection liquid L.

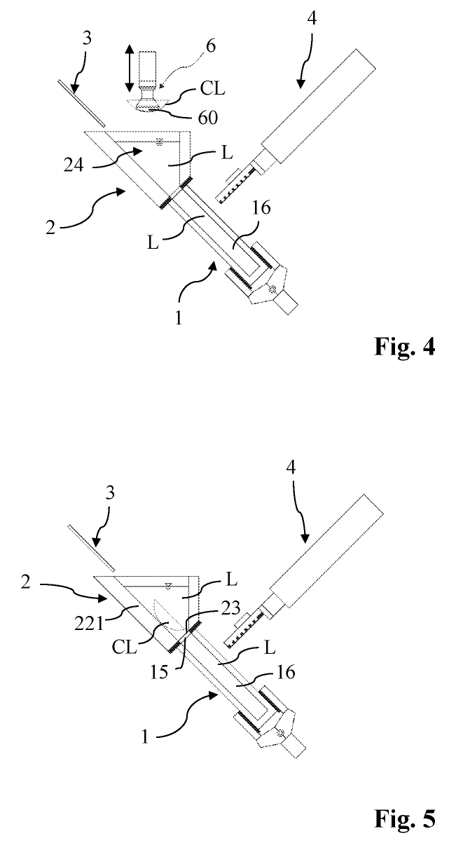

As is shown in FIG. 4, the next step is insertion of the ophthalmic lens CL, e.g. a contact lens, into the inspection cuvette 1, to be more precise into interior space 16 of inspection cuvette 1. For that reason, the apparatus comprises a lens gripper 6 having a gripper head 60 (distal end of lens gripper 6) to which the ophthalmic lens CL adheres (e.g. through the application of suction through a hollow gripper shaft and through openings extending through the gripper head). Lens gripper 6 is arranged to be movable down through the funnel top opening 21 into filling and placement funnel 2, to be more precise into the interior space 24 of filling and placement funnel 2 and into the inspection liquid L contained therein. The ophthalmic lens CL is then released from gripper head 60 (e.g. through the application of overpressure through the hollow gripper shaft and the openings extending through the gripper head) into the inspection liquid L contained in the interior space 24 of filling and placement funnel 2. Lens gripper 6 is then moved up again to a position above filling and placement funnel 2 (movement of lens gripper 6 indicated by the double-headed arrow).

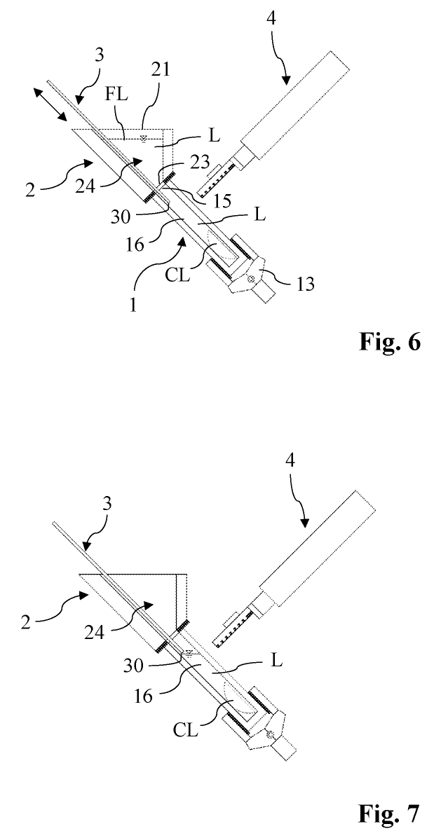

Once released from the lens gripper 6, due to gravity the ophthalmic lens CL travels down in the inspection liquid L in the interior space 24 of filling and placement funnel 2 until it comes to rest on an inner surface of inclined funnel wall portion 221, as is shown in FIG. 5. The ophthalmic lens CL orients itself as is shown in FIG. 5 and slides along the inner surface of inclined funnel wall portion 221 towards and through funnel bottom opening 23, through cuvette top opening 15, and further down in the inspection liquid L contained in the interior space 16 of inspection cuvette 1 until it reaches the final position at the bottom wall 13 of inspection cuvette 1, as shown in FIG. 6, Due to the angle α being selected from the range of 30° to 60°, and in particular being 45°, the ophthalmic lens CL reliably slides into the inspection cuvette 1 within a reasonable timeframe. Too small an angle α may decrease the time needed for the ophthalmic lens CL to slide into the interior space 16 of inspection cuvette 1, but may increase the risk that the ophthalmic lens may inadvertently turn upside down so that it does not have the desired orientation in the inspection cuvette 1. Too large an angle α may increase the time needed for the lens CL to slide into the interior space 16 of inspection cuvette 1, or - depending on the angle α - may not be sufficient anymore to allow the ophthalmic lens CL to slide into the interior space 16 of inspection cuvette 1.

The next step is introduction and movement of the suction supply tube 3 to an active position in which the suction supply tube 3 extends through the funnel top opening 21, the interior space 24, the funnel bottom opening 23 and the cuvette top opening 15, until the distal end 30 of suction supply tube 3 is arranged in the cuvette interior space 16 at a location close to the cuvette top opening 15. This situation is shown in FIG. 6.

To be able to spatially separate the filling and placement funnel 2 and the inspection cuvette 1 from each other (in order to allow further handling of inspection cuvette 1 filled with inspection liquid L and containing the ophthalmic lens CL immersed therein), first the inspection liquid L contained in the interior space 24 of filling and placement funnel 2 must be removed to avoid spillage of the inspection liquid L. This is done through the application of vacuum (suction), with the suction supply tube 3 arranged in the active position shown in FIG. 6, and is finished at the time at least 70% to 80% of the volume of the interior space 16 of inspection cuvette 1 is still filled with inspection liquid L, while the ophthalmic lens CL is contained therein immersed in the inspection liquid L. This situation is shown in FIG. 7. Thereafter, suction supply tube 3 is moved from the active position back to the inactive position in which it is arranged completely outside the filling and placement funnel 2 (see FIG. 1 - FIG. 5).

Cuvette holder 10 then moves inspection cuvette 1 away from filling and placement funnel 2 along the longitudinal axis 160 of the cubic interior space 16 of inspection cuvette 1 to a cleaning position, in which the slider 41 of wiper 4 is moved out of the stator 40 to the extended position shown in FIG. 8. In this extended position of slider 41, the contact surface of liquid removal head 42 contacts the end faces of the cuvette walls that surround cuvette top opening 15, to remove any liquid possibly adhering to these end faces and which may lead to problems in lens inspection (e.g. when the liquid flows down on the outer surface of a cuvette wall). Removal of the liquid may be performed with the aid of suction supplied to the contact surface of removal head 42, or with the aid of capillary forces exerted upon the liquid by a capillary structure of the contact surface of removal head 42, or may be performed by any other suitable mechanism.

Once removal of inspection liquid from the end faces of the cuvette walls surrounding cuvette top opening 15 is completed, cuvette holder 10 moves inspection cuvette 1 further away in the direction of the longitudinal axis 160 of the cubic interior space 16 of inspection cuvette 1 to the position shown in FIG. 9 which corresponds to the initial position shown in FIG. 1. The inspection cuvette 1 with the ophthalmic lens CL contained therein immersed in the inspection liquid L may now be moved to an inspection station (not shown) where the ophthalmic lens CL is inspected.

After lens inspection is completed, it may be necessary or desirable to retrieve the ophthalmic lens from the inspection cuvette, for example if the lens inspection systems used should be verified for accuracy, or if new types of defects that should be further examined are found in the lens inspection, or for inspections with other inspection methods, or for any other purposes.

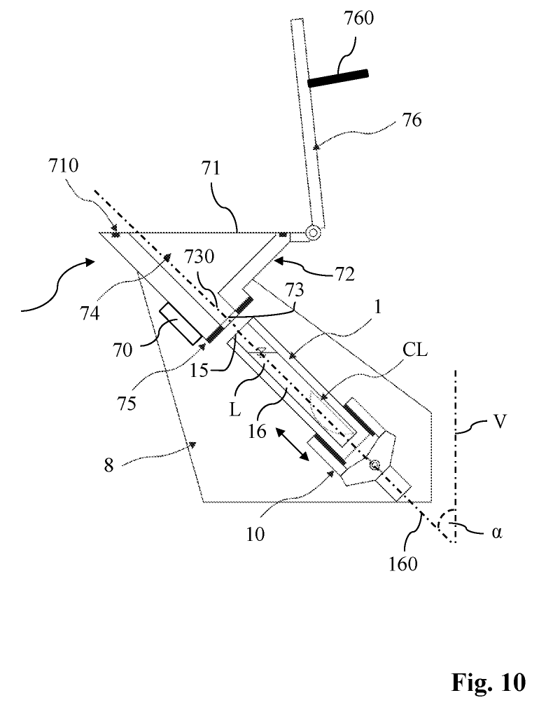

To retrieve the ophthalmic lens CL from inspection cuvette 1, the embodiment of the apparatus according to the invention may further comprise an emptying and removal funnel 7, as is shown in FIG. 10. Emptying and removal funnel 7 has a funnel top opening 71, a funnel wall 72, and a funnel bottom opening 73, together defining an interior space 74 of the emptying and removal funnel. A seal 75 is arranged at the funnel bottom opening 73, and surrounds the funnel bottom opening 73. Funnel bottom opening 73 is rectangular and has a size that is equal to or a little larger than the size of rectangular cuvette top opening 15. Emptying and removal funnel 7 further comprises a lid 76 that is movably arranged (here: pivotally arranged) between a closed position in which the lid 76 closes the funnel top opening 71 in a liquid-tight manner and an open position. To open and close the lid 76, an actuator 760 is attached to lid 76. A seal 710 (e.g. a sealing ring) is arranged to surround funnel top opening 71, so that once the lid 76 is in the closed position the funnel top opening 71 is closed in a liquid-tight manner.

The apparatus comprises a further funnel holder 70 for holding emptying and removal funnel 7. Further funnel holder 70 holds emptying and removal funnel 7 at a funnel start orientation at which a funnel outlet axis 730 of emptying and removal funnel 7 that runs normal to and through the funnel bottom opening 73 is arranged coincident with the longitudinal axis 160 of the cubic cuvette interior space 16 when the cuvette holder 10 holds the inspection cuvette 1 at the cuvette filling and placement orientation at which the longitudinal axis 160 of the cuvette interior space 16 includes the acute angle α with the vertical V, and at which the cuvette top opening is arranged to face generally upwardly. This acute angle α included by the longitudinal axis 160 of the cubic interior space 16 and the vertical V is in a range of 30° to 60°, and in the embodiment shown it is 45° as is already described above. Cuvette holder 10 holding inspection cuvette 1 at the cuvette filling and placement orientation and further funnel holder 70 holding the emptying and removal funnel 7 at the funnel start orientation are movable relative to each other to an emptying and removal connection position and away from the emptying and removal connection position. The apparatus further comprises a rotatable support 8, on which cuvette holder 10 and the further funnel holder 70 are arranged.

In the following, with the aid of an embodiment of the apparatus an embodiment of those steps of the method according to the invention related to the removal/retrieval of the lens CL from the inspection cuvette 1 will be explained step by step.

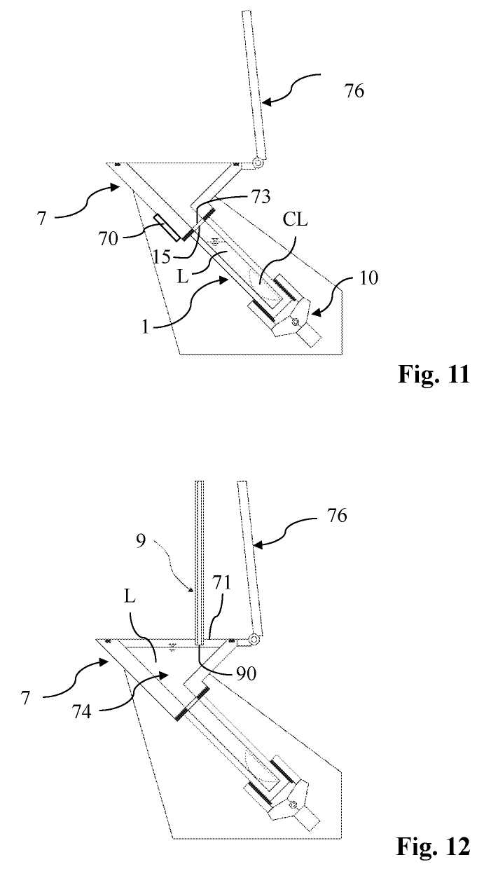

First of all, when the cuvette holder 10 holds inspection cuvette 1 at the cuvette filling and placement orientation and the further funnel holder 70 holds the emptying and removal funnel 7 at the funnel start orientation (as shown in FIG. 10), further funnel holder 70 and the inspection cuvette holder 10 are moved relative to each other to an emptying and removal connection position, as shown in FIG. 11. In this emptying and removal connection position, a liquid-tight connection is formed between the funnel bottom opening 73 of the emptying and removal funnel 7 and the cuvette top opening 15. This liquid-tight connection is formed by means of the seal 75 surrounding the funnel bottom opening 73. Lid 76 of emptying and removal funnel 7 is in the open position. In the embodiment, cuvette holder 10 is movable towards emptying and removal funnel 7 which is held stationary on further funnel holder 70.

Next, the emptying and removal funnel 7 is filled with inspection liquid L up to a predetermined level which corresponds to at least 70%-80% of the volume of the interior space 74 of emptying and removal funnel 7 being filled with inspection liquid L. As shown in FIG. 12, the apparatus may comprise a further liquid supply tube 9 having a liquid supply tube outlet 90 that is positionable at or above the funnel top opening 71. Inspection liquid L is then filled into the interior space 74 of emptying and removal funnel 7 up to the predetermined level.

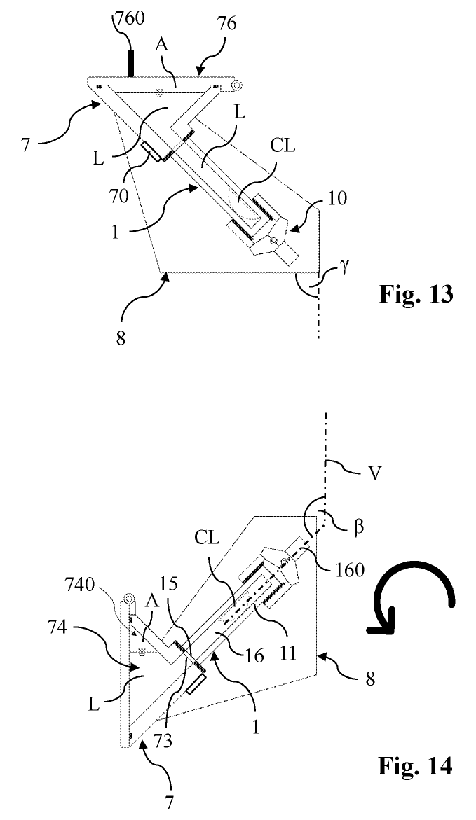

Thereafter, the lid 76 of emptying and removal funnel 7 is closed (liquid-tight) with the aid of actuator 760.This state is shown in FIG. 13.

Next, rotatable support 8 on which further funnel holder 70 (holding emptying and removal funnel 7) and cuvette holder 10 (holding inspection cuvette 1) are arranged, is rotated by a predetermined rotational angle γ of e.g. 90° (see FIG. 13) to an emptying and removal orientation, as this is indicated by the arrow in FIG. 14. in which the longitudinal axis 160 of the cuvette interior space 16 is arranged to include an obtuse angle β with the vertical V, and in which the cuvette top opening 15 is arranged to face generally downwardly (i.e. in a direction below a horizontal). This obtuse angle β is within a range of 120° to 150°, and in the embodiment shown is 135°.

In the emptying and removal orientation, due to gravity the ophthalmic lens CL starts sliding along an inner surface of the front wall 11 of inspection cuvette 1 out of cuvette interior space 16 of inspection cuvette 1 and through cuvette top opening 15 (facing generally downwardly) and funnel bottom opening 73 into the interior space 74 of emptying and removal funnel 7 until it finally abuts against lid 76 which is still in the closed position. As can be seen in FIG. 14, interior space 74 of emptying and removal funnel 7 comprises a portion 740 that is arranged at a level above cuvette top opening 15 when the rotatable support 8 is arranged at the emptying and removal orientation, and the volume of this portion is large enough to accommodate the volume of air A arranged between the upper surface of the inspection liquid L and the lid 76 (see FIG. 13).

When glancing at both FIG. 13 and FIG. 14 showing the components before (FIG. 13) and after (FIG. 14) rotation of the rotational support, it is noteworthy that during rotation of rotatable support 8 care must be taken that the interior space 16 of inspection cuvette 1 remains completely filled with inspection liquid L at any time during rotation. Or to say it in other words: During rotation of rotational support 8, the small volume of air A arranged between the upper surface of inspection liquid L and the lid 76 of emptying and removal funnel 7 before rotation (see FIG. 13) is entirely displaced into portion 740 of emptying and removal funnel 7 which is arranged above the level of cuvette top opening 15 or funnel bottom opening 73 (see FIG. 14) when emptying and removal funnel 7 is arranged at the emptying and removal orientation. This prevents any air from entering the interior space 16 of inspection cuvette 1, which may otherwise negatively affect the process of the ophthalmic lens CL sliding along the inner surface of front wall 11 out of inspection cuvette 1 and into emptying and removal funnel 7.

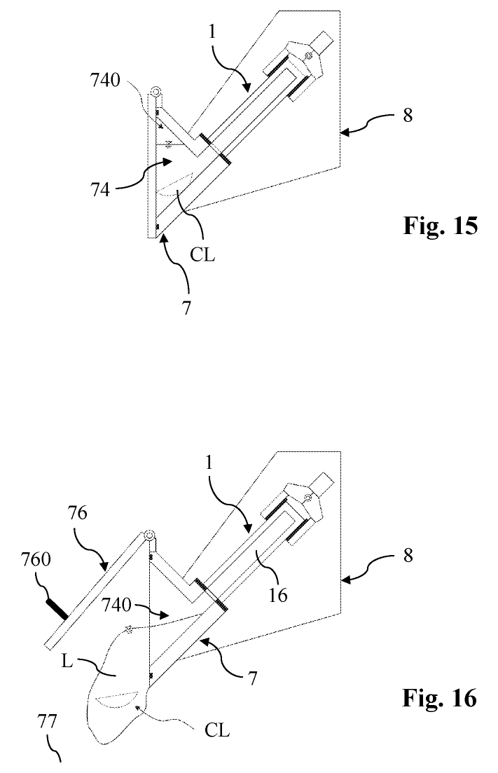

Once the ophthalmic lens CL is arranged in the inspection liquid L contained in the interior space 74 of emptying and removal funnel 7 as described above, the ophthalmic lens CL is ready for being retrieved. This is shown in FIG. 15.

Opening the lid 76 of emptying and removal funnel 7 with the aid of actuator 760, as shown in FIG. 16, allows the inspection liquid L to be flushed out of the interior space 74 of emptying and removal funnel 7 as well as out of the interior space 16 of inspection cuvette 1 through funnel top opening 71. Together with the inspection liquid, the ophthalmic lens CL is flushed out of emptying and removal funnel 7 and may be retained by a mesh 77. The ophthalmic lens CL may then be picked up from the mesh 77, whereby retrieval of the ophthalmic lens CL is completed.

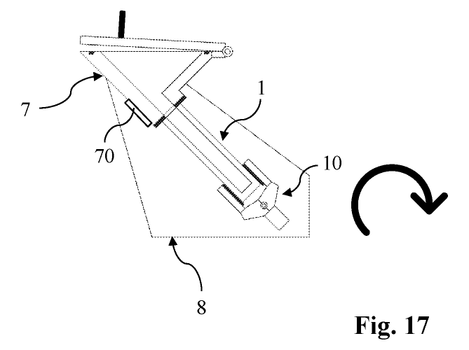

Rotatable support 8 is then rotated back by the predetermined angle γ to its original orientation (see FIG. 13), as this is indicated by the arrow shown in FIG. 17, and further funnel holder 70 and cuvette holder 10 are moved away from the emptying and removal connection position (not shown in FIG. 17).

Any liquid that may adhere to cuvette top opening 15 may then be removed with the aid of wiper 4, similar to how this has been described above in connection with FIG. 8.

The method is then complete, the ophthalmic lens CL has first been inserted into the inspection cuvette 1 with the aid of filling and placement funnel 2, as described above, then inspected in the inspection cuvette 1, and thereafter the ophthalmic lens CL has been retrieved from the inspection cuvette 1 again with the aid of emptying and removal funnel 7.

While an embodiment of the invention is described above with the aid of the drawings, the invention is not limited to this embodiment. Rather, various changes and modifications are possible which are within the scope of protection defined by the appended claims.

1. Apparatus for use in the inspection of an ophthalmic lens, in particular a contact lens such as a soft contact lens, the apparatus comprising:
an inspection cuvette (1) made of a transparent material and having a cubic shape, the inspection cuvette (1) comprising a front wall (11), a rear wall (12), two sidewalls (14), a bottom wall (13) and a rectangular cuvette top opening (15), wherein the front wall (11), the rear wall (12), the two sidewalls (14) and the bottom wall (13) together define a cuvette interior space (16) that is cubic and has a predetermined length (l), a predetermined width (w) and a predetermined depth (d), and further define the rectangular cuvette top opening (15);
filling and placement funnel (2) comprising a funnel top opening (21) and a funnel bottom opening (23), and further comprising a seal (25) arranged at the funnel bottom opening (23) and surrounding the funnel bottom opening (23), wherein the funnel bottom opening (23) is rectangular and has a size that is equal to or smaller than the size of the rectangular cuvette top opening (15);
(10) for holding the inspection cuvette (1);
(20) for holding the filling and placement funnel (2);
cuvette holder (10) is configured to hold the inspection cuvette (1) at a cuvette filling and placement orientation, at which a longitudinal axis (160) of the cuvette interior space (16) that extends in the direction of the length (l) of the cuvette interior space (16) and that runs normal to and through the cuvette top opening (15) includes an acute angle (α) with a vertical (V), and at which the cuvette top opening (15) is arranged to face generally upwardly,
(20) is configured to hold the filling and placement funnel (2) at a funnel filling and placement orientation at which a funnel outlet axis (230) of the filling and placement funnel (2) that runs normal to and through the funnel bottom opening (23) is arranged coincident with the longitudinal axis (160) of the cuvette interior space (16) when the cuvette holder (10) holds the inspection cuvette (1) at the cuvette filling and placement orientation;
and wherein, when the cuvette holder (10) holds the inspection cuvette (1) at the cuvette filling and placement orientation and the funnel holder (20) holds the filling and placement funnel (2) at the funnel filling and placement orientation, the inspection cuvette holder (10) and the funnel holder (20) are configured to be movable relative to each other to a filling and placement connection position, in which a liquid-tight connection between the funnel bottom opening (23) of the filling and placement funnel (2) and the cuvette top opening (15) is formed by means of the seal (25) surrounding the funnel bottom opening (23), and away from this filling and placement connection position to release the liquid-tight connection.

2. Apparatus according to claim 1, wherein the acute angle (α) included by the longitudinal axis (160) of the cubic interior space (16) and the vertical (V) is in a range of 30° to 60°, and especially is about 45°.

3. Apparatus according to claim 1, further comprising a liquid supply tube (5) having a liquid supply tube outlet (50) positionable at or above the funnel top opening (21) of the filling and placement funnel (2), for the supply of inspection liquid (L) into the cuvette interior space (16) through the funnel top opening (21), the funnel bottom opening (23) and the cuvette top opening (15), and further into the filling and placement funnel (2), when the cuvette holder (10) and the funnel holder (20) are arranged in the filling and placement connection position.

4. Apparatus according to claim 1, further comprising a suction supply tube (3) arranged to be movable to an active position in which the suction supply tube (3) extends through the funnel top opening (21), the funnel bottom opening (23) and the cuvette top opening (15) into the cuvette interior space (16) when the cuvette holder (10) and the funnel holder (20) are arranged in the filling and placement connection position, and to an inactive position in which the suction supply tube (3) is completely arranged outside the filling and placement funnel (2).

5. Apparatus according to claim 1, further comprising a wiper (4, 40, 41, 42) arranged to be movable to a cleaning position in which the wiper (4, 40, 41, 42) contacts the end faces of the walls of the inspection cuvette that surround the cuvette top opening (15), i.e. the end faces of the front wall (11), the rear wall (12), and the two sidewalls (14), when the cuvette holder (10) and the funnel holder (20) are arranged away from the filling and placement connection position, and to a remote position in which the wiper (4, 40, 41, 42) is arranged remote from the cuvette top opening (15).

6. Apparatus according to claim 1, further comprising a lens gripper (6) arranged to be movable through the funnel top opening (21) into the filling and placement funnel (2), for insertion of an ophthalmic lens in the filling and placement funnel (2).

7. Apparatus according to claim 1, further comprising:
an emptying and removal funnel (7) having a funnel top opening (71) and a funnel bottom opening (73), a lid (76) movably arranged between a closed position in which the lid (76) closes the funnel top opening (71) in a liquid-tight manner and an open position, and a seal (75) arranged at the funnel bottom opening (73) and surrounding the funnel bottom opening (73), wherein the funnel bottom opening (73) is rectangular and has a size that is equal to or larger than the size of the rectangular cuvette top opening (15);
(70) for holding the emptying and removal funnel (7);
wherein the further funnel holder (70) is configured to hold the emptying and removal funnel (7) at a funnel start orientation at which a funnel outlet axis (730) of the emptying and removal funnel (7) that runs normal to and through the funnel bottom opening (73) is arranged coincident with the longitudinal axis (160) of the cubic cuvette interior space (16) when the cuvette holder (10) holds the inspection cuvette (1) at the cuvette filling and placement orientation at which the longitudinal axis (160) of the cuvette interior space (16) includes the acute angle (α) with the vertical (V), and at which the cuvette top opening (15) is arranged to face generally upwardly;
, when the cuvette holder (10) holds the inspection cuvette (1) at the cuvette filling and placement orientation and the further funnel holder (70) holds the emptying and removal funnel (7) at the funnel start orientation, the further funnel holder (70) and the inspection cuvette holder (10) are configured to be movable relative to each other to an emptying and removal connection position, in which a liquid-tight connection between the funnel bottom opening (73) of the emptying and removal funnel (7) and the cuvette top opening (15) is formed by means of the seal (75) surrounding the funnel bottom opening (73), and away from this removal and emptying connection position to release the liquid-tight connection.

8. Apparatus according to claim 7, comprising a further liquid supply tube (9) having a liquid supply tube outlet (90) positionable at or above the funnel top opening (71) when the further funnel holder (70) and the cuvette holder (10) are arranged in the emptying and removal connection position and hold the emptying and removal funnel (7) at the funnel start orientation and the inspection cuvette (1) at the cuvette filling and placement orientation, for filling the emptying and removal funnel (7) with an inspection liquid.

9. Apparatus according to claim 7, further comprising a rotatable support on which the cuvette holder (10) and the further funnel holder (70) are arranged, the rotatable support (8) being configured to rotate the cuvette holder (10) and the further funnel holder (70) arranged thereon in the emptying and removal connection position by a predetermined rotational angle (γ) to an emptying and removal orientation in which the longitudinal axis (160) of the cuvette interior space (16) is arranged to include an obtuse angle (β) with the vertical (V), and in which the cuvette top opening (15) is arranged to face generally downwardly.

10. Apparatus according to claim 9, wherein the emptying and removal funnel (7) has an interior space (74) comprising a portion (740) that is arranged at a level above the cuvette top opening (15) when the rotatable support (8) is arranged at the emptying and removal orientation.

11. A method for handling an ophthalmic lens (CL) in lens inspection, the method comprising:
- providing an apparatus according to claim 1;
(10) holding the inspection cuvette (1) at the cuvette filling and placement orientation and the funnel holder (20) holding the filling and placement funnel (2) at the funnel filling and placement orientation relative to each other to the filling and placement connection position to form the liquid-tight connection between the funnel bottom opening (23) of the filling and placement funnel (2) and the cuvette top opening (15);
(L) through the funnel top opening (21), the funnel bottom opening (23) and the cuvette top opening (15) into the inspection cuvette (1) until the cuvette interior space (16) is completely filled with inspection liquid (L), and then continuing to fill inspection liquid (L) through the funnel top opening (21) into the filling and placement funnel (2) up to a predetermined level (FL);
(CL) to be inspected in the inspection liquid (L) in the filling and placement funnel (2) through the funnel top opening (21), and allowing the ophthalmic lens (CL) placed in the inspection liquid (L) to settle down and move through the funnel bottom opening (23) and the cuvette top opening (15) into the inspection liquid (L) contained in the cubic interior space (16) of the cubic inspection cuvette (1);
inspection liquid (L) from the filling and placement funnel (2) while keeping the inspection cuvette (1) filled with inspection liquid (L)and retaining the ophthalmic lens (CL) immersed in the inspection liquid (L) contained in the inspection cuvette (1); and
- moving the cuvette holder (10) holding the inspection cuvette (1) with the inspection liquid (L) and the ophthalmic lens (CL) immersed therein and the filling and placement funnel (2) away from the filling and placement position.

12. Method according to claim 11, further comprising the step of
(L), if any, from the end faces of the front wall (11), the rear wall (12), and the two sidewalls (14) surrounding the cuvette top opening (15) of the inspection cuvette (1), when the cuvette holder (10) and the funnel holder (2) are arranged away from the filling and placement connection position.

13. Method according to claim 11, further comprising the steps of
(70) holding the emptying and removal funnel (7) at the funnel start orientation, with the lid (76) in the open position;
(10) holding the inspection cuvette (1) with the inspection liquid (L) and the ophthalmic lens (CL) immersed therein at the filling and placement orientation;
cuvette holder (10) and the further funnel holder (70) relative to each other to the emptying and removal position in which a liquid-tight connection between the funnel bottom opening (73) of the emptying and removal funnel (7) and the cuvette top opening (15) is formed;
(7) with inspection liquid (L) through the funnel top opening (71) up to a predetermined level;
(76) of the emptying and removal funnel (7);
the rotational support (8) on which the cuvette holder (10) and the further funnel holder (70) are arranged in the emptying and removal position to the emptying and removal orientation, thus allowing the ophthalmic lens (CL) to slide out of the inspection cuvette (1) into the emptying and removal funnel (7); and
moving the lid (76) of the emptying and removal funnel (7) to the open position, thus removing the ophthalmic lens (CL) and the inspection liquid (L) from the emptying and removal funnel (7) and the inspection cuvette (1).

14. Method according to claim 13, further comprising the steps of:
ophthalmic lens (CL) and the inspection liquid (L) from the emptying and removal funnel (7) and the inspection cuvette (1), rotating the rotational support (8) from the emptying and removal orientation back to the funnel start orientation, and
moving the further funnel holder (70) and the cuvette holder (10) away from the emptying and removal position to release the liquid-tight connection between the funnel bottom opening (73) of the emptying and removal funnel (7) and the cuvette top opening (15).
